(19) United States
(12) Patent Application Publication
(10) Pub. No.: US 2018/0032580 A1
(43) Pub. Date: Feb. 1, 2018

(54) ACCELERATING ROCKSDB MULTI-INSTANCE PERFORMANCE BY INTRODUCING RANDOM INITIATION FOR COMPACTION

(71) Applicant: Samsung Electronics Co., Ltd., Suwon-si (KR)

(72) Inventor: Zvi Guz, Palo Alto, CA (US)

(21) Appl. No.: 15/256,431

(22) Filed: Sep. 2, 2016

Related U.S. Application Data
(60) Provisional application No. 62/367,068, filed on Jul. 26, 2016.

(51) Int. Cl. G06F 17/30

(52) U.S. Cl. CPC G06F 17/30501; G06F 17/30371

(57) ABSTRACT

A method of managing a database, the method including determining whether a deterministic threshold has occurred, determining whether a random threshold has occurred, and initiating a maintenance process on the database when either the deterministic threshold or the random threshold has occurred.

### CROSS-REFERENCE TO RELATED APPLICATION

This application claims priority to, and the benefit of, U.S. Provisional Application 62/367,068, filed on Jul. 26, 2016 in the U.S. Patent and Trademark Office, the entire content of which is incorporated herein by reference.

### FIELD

One or more aspects of embodiments according to the present invention relate to shared resource scheduling, such as database maintenance and data storage.

### BACKGROUND

RocksDB is open-source software that provides an embeddable database for key-value data to provide low-latency memory storage and database accesses (reads and writes). That is, RocksDB is an increasingly popular key-value persistent store library and database management system that is directly integrated with application software to access and manage associative arrays/tables (e.g., arbitrary byte arrays, or hash arrays, comprising a collection of key-value pairs, with no data value appearing more than once). Accordingly, keys and values are stored in byte arrays, and data is sorted byte-wise by key.

RocksDB is written in the programming language C++, and uses a log-structured merge-tree data structure to provide high insert volume. Because RocksDB provides official application programming interface (API) language bindings for C++, C, Java, and other 3rd-party language bindings, RocksDB enables efficient use of fast storage (e.g., flash memory, solid-state drives, etc.), and is scalable to run on servers with multiple CPU cores. RocksDB is therefore used by many different software applications, software infrastructures, and software stacks (e.g., Ceph, Redis-on_Flash, RedisLabs Enterprise Cluster, MongoRocks, MyRocks, etc.) to maintain and abstract storage management, and to provide fast disk access.

RocksDB stores and manages data via several data structures in memory and on disk. To effectively maintain a database/library, which may be stored as a number of tables respectively located on multiple disk drives, when these data structures are filled with data such that a predefined watermark is reached, RocksDB may cause the initiation of one or more background maintenance processes (e.g., compaction processes). Accordingly, the background maintenance processes can be used for scrubbing tables, removing duplications of key-value pairs, processing deletions of keys, etc.

The background maintenance processes may be initiated by RocksDB when the associative tables achieve or arrive at some deterministic metric (e.g., when a table of the library reaches a configured threshold of capacity, such as 80% capacity). However, several instances of RocksDB can be spawned by the same application software operating multiple shards, or instances, on the same machine to thereby access the same disk drive, or plurality of disk drives, which have the RocksDB library stored thereon. Furthermore, certain background maintenance processes, such as compaction, are disk intensive due to the use of several read requests and write requests, and may therefore create temporal spikes in disk traffic/disk load.

As mentioned, multiple shards may concurrently access the RocksDB library/database. Database sharding may be thought of as a partitioning scheme for large libraries that are stored across a number of servers/disk drives, where no data is shared across the servers (i.e., only unique key-value pairs are stored in the corresponding library). By breaking the large library into multiple shards, system performance may be improved, and scalability may be increased. That is, the library may be divided or partitioned into shards, which may be assigned to a respective one of a number of distributed servers/disk drives.

When multiple shards concurrently access the RocksDB library stored on the disk drive(s), and therefore concurrently access the same disk drive(s), the resulting spikes in disk traffic can cause a noticeable increase in observed latency of read and/or write requests due to an increase in tail latencies. The increase in observed latency is especially true for disk-intensive applications. The level of latency during the spikes in disk traffic can dictate aspects of system performance.

Because applications may impose an allowable limit on tail latency, unwanted spikes in disk traffic may warrant that the system running RocksDB be balanced to ensure that proper limits, or service requirements, are met. That is, the system may be balanced to reduce the magnitude and/or frequency of the spikes in disk traffic to maintain service requirements even during times of high levels of disk traffic.

Accordingly, it may be useful to provide a system and method for reducing system latencies resulting from concurrent processing of background maintenance processes of a database. That is, it may be suitable to interleave background maintenance processes to eliminate pathological cases where multiple maintenance processes run concurrently to unnecessarily overburden system resources. The reduction of system latencies may improve performance of, for example, RocksDB, or any other memory storage database that may be accessed by multiple entities at the same time.

### SUMMARY

Aspects of embodiments of the present disclosure are directed toward scheduling of shared resources, such as database maintenance and data storage with RocksDB.

According to an embodiment of the present invention, there is provided a method of managing a database, the method including determining whether a deterministic threshold has occurred, determining whether a random threshold has occurred, and initiating a maintenance process on the database when either the deterministic threshold or the random threshold has occurred.

The random threshold may correspond to a start time.

The method may further include configuring a first interval and a second interval, wherein the start time randomly occurs between the first interval and the second interval, the first and second intervals being configurable.

Configuring of the first interval and the second interval may include setting the first interval and the second interval to 0 or less, the result is such that the random threshold's corresponding start time does not occur.

Configuring of the first interval and the second interval may include setting the first interval and the second interval to be equal to each other results in the maintenance process on the database starting at a fixed time.

The method may further include reconfiguring the first interval and the second interval upon determining that the random threshold has occurred.

The maintenance process may be compaction of one or more tables of the database.

The database may include a key-value store library.

The deterministic threshold may correspond to a capacity of a table of the database.

According to another embodiment of the present invention, there is provided a database management system for maintaining a database, the system including a user device including a processor, and memory having stored instructions that, when executed by the processor, cause the processor to determine whether a deterministic threshold has occurred, determine whether a random threshold has occurred, and initiate a maintenance process on the database when either the deterministic threshold or the random threshold has occurred.

The random threshold may correspond to a start time.

The system may further include configuring a first interval and a second interval, wherein the start time randomly occurs between the first interval and the second interval, the first and second intervals being configurable.

Configuring of the first interval and the second interval may include setting the first interval and the second interval to 0 or less, the result is such that the random threshold's corresponding start time does not occur.

Configuring of the first interval and the second interval may include setting the first interval and the second interval to be equal to each other results in the maintenance process on the database starting at a fixed time.

The system may further include reconfiguring the first interval and the second interval upon determining that the random threshold has occurred.

The maintenance process may be compaction of one or more tables of the database.

The database may include a key-value store library.

The deterministic threshold may correspond to a capacity of a table of the database.

According to another embodiment of the present invention, there is provided a method of scheduling access to a shared resource, the method including determining whether a deterministic threshold has occurred, determining whether a random threshold has occurred, and permitting access to the shared resource when either the deterministic threshold or the random threshold has occurred.

Entities accessing the shared resource may individually determine whether the deterministic threshold or the random threshold has occurred.

### BRIEF DESCRIPTION OF THE DRAWINGS

These and other aspects of the present invention will be appreciated and understood with reference to the specification, claims, and appended drawings wherein:

FIG. 1 is a diagram depicting a system of a database network including a plurality of user devices, a scheduling server, and a plurality of disk drives, according to an embodiment of the present invention;

FIG. 2 is a flowchart for a conventional method of initiating a background maintenance process of a database;

FIGS. 3A, 3B, 3C, and 3D depict system characterization of a contemporary multi-shards database performing the conventional method of initiating the background maintenance process of FIG. 2;

FIG. 4 is a flowchart for a method of initiating a background maintenance process of a database according to an embodiment of the present invention;

FIGS. 5A, 5B, 5C, and 5D depict system characterization of a multi-shards database performing the method of initiating the background maintenance process of the embodiment shown in FIG. 4, according to experimental results; and

FIGS. 6A and 6B are flowcharts for methods of initiating a background maintenance process of a database according to an embodiment of the present invention.

### DETAILED DESCRIPTION

Features of the inventive concept and methods of accomplishing the same may be understood more readily by reference to the following detailed description of embodiments and the accompanying drawings. Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element, layer, region, or component is referred to as being “on,” “connected to,” or “coupled to” another element, layer, region, or component, it can be directly on, connected to, or coupled to the other element, layer, region, or component, or one or more intervening elements, layers, regions, or components may be present. In addition, it will also be understood that when an element or layer is referred to as being “between” two elements or layers, it may be the only element or layer between the two elements or layers, or one or more intervening elements or layers may also be present.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

When a certain embodiment may be implemented differently, a specific process order may be performed differently from the described order. For example, two consecutively described processes may be performed substantially at the same time or performed in an order opposite to the described order.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

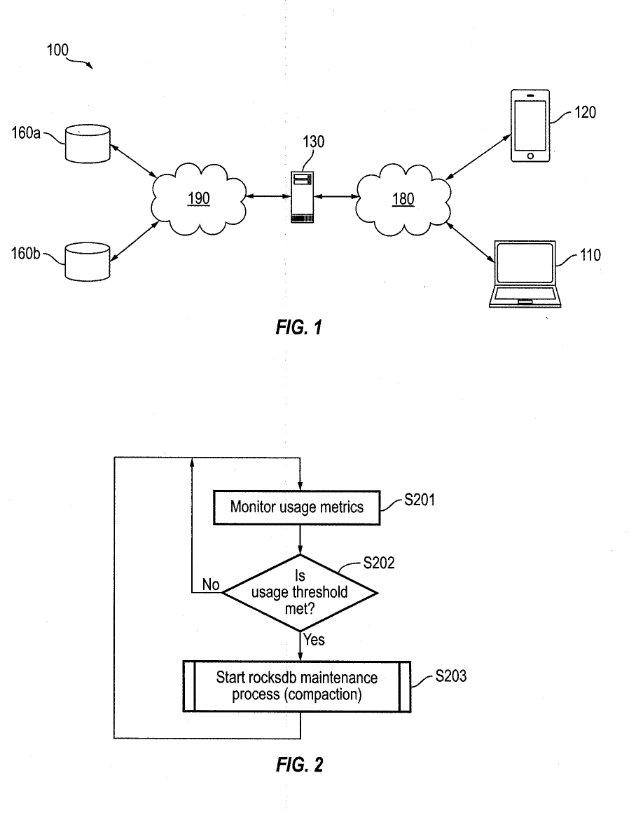

FIG. 1 is a diagram depicting a system of a database network including a plurality of user devices, a scheduling server, and a plurality of disk drives, according to an embodiment of the present invention.

As can be seen in FIG. 1, in a database network system 100, multiple entities/user devices 110 and 120 can use a database program, such as, and for example, RocksDB, to store and access data, such as key-value pairs, the data being stored in a library/database. Although RocksDB is repeatedly referenced in the description that follows, embodiments of the present invention are equally applicable to any system that allows multiple entities to access shared resources, and that includes a triggering event that causes several of the entities to access the shared resource at a same time. Such systems may include another type of shared database. That is, embodiments of the present invention may be used when there is a shared resource, and multiple entities that are sharing the resource have a predetermined method of accessing the resource.

The library may store relatively large amounts of data, may be located on one or more disk drives 160a and/or 160b, and may allow access to the stored data by one or more of the user devices 110 and/or 120. Although only two user devices 110 and 120 are shown in FIG. 1, multiple other user devices (e.g., dozens, hundreds, or more) may also be authorized to access the library (e.g., using RocksDB). Furthermore, multiple software applications on a single one of the user devices 110 or 120 may operate in parallel on the same user device 110 or 120 to independently access the library located on the disk drive(s) 160a and/or 160b. Each of the user devices 110 and 120 has a processor, and a memory for running the software application(s) that allow the user devices to access and manage the data located on the one or more disk drives 160a and/or 160b.

Although RocksDB is provided as an example, embodiments of the present invention may be applied to other scenarios where access by a plurality of entities to a shared resource(s) is scheduled to avoid conflicts. For example, embodiments of the present invention may be applied to other software for memory storage and database access and maintenance. That is, embodiments of the present invention are applicable for any service where a resource-heavy maintenance process is started deterministically as a function of internal structure usage, or where multiple concurrently running instances of the same service use the same commonly shared resources.

The user devices 110 and 120 execute read requests and write requests to the library (i.e., requests to retrieve data stored in the library, and requests to record data to the library, respectively) using a scheduling server 130 that is connected to the user devices 110 and 120 via a first network 180 (e.g., the internet). The scheduling server 130 is able to access the library via a second network 190 that connects the scheduling server 130 to the one or more disk drives 160a and/or 160b.

In the present embodiment, RocksDB uses the scheduling server 130 to schedule unique recordings of key-value pairs in the library in accordance with the write requests received from the user devices 110 and 120. Accordingly, unique key-value pairs corresponding to the write requests are saved into the structure of RocksDB, where some of key-value pairs may be saved to memory, while others may be saved to storage. Similarly, when the user devices 110 and 120 execute read requests to retrieve data from the library stored on the disk drive(s) 160a and/or 160b, the scheduling server 130 coordinates the read requests to retrieve the requested data from the library over the second network 190, and then delivers the requested key-value data to the corresponding user devices 110 and 120 over the first network 180. It should be noted that, in other embodiments, the disk drive(s) 160a and/or 160b, the user devices 110 and 120, and the scheduling server 130 may all be connected to a same network.

RocksDB occasionally causes background maintenance processes to run. Such background maintenance processes will cause communication with the internal structures of the library stored on the disk drive(s) 160a and/or 160b. That is, RocksDB typically has various different independent tables for storing key-value data, the different tables collectively forming the library. RocksDB may initiate background maintenance processes to, for example, scrub the tables, remove duplicate key-value pairs, move key-value pairs around within or across the independent tables of the library to improve performance of the system 100, etc.

Conventionally, many types of background maintenance processes may be initiated by RocksDB once some corresponding deterministic threshold relating to one or more aspects of the library is met. For example, tables of the library have a limited capacity, and once the amount of available capacity reaches a particular threshold (e.g., once only 20% capacity remains in a table), one or more of the corresponding user devices 110 and 120 may be instructed by RocksDB to initiate a particular background maintenance process (e.g., compaction). A conventional logic flow that causes the concurrent initiation of background processes by multiple shards is shown in FIG. 2.

FIG. 2 is a flowchart for a conventional method of initiating a background maintenance process of a database.

Multiple, different instances of a software application may be referred to as “shards.” When multiple shards access the library that is maintained by RocksDB, and that is stored on the disk drive(s) 160a and/or 160b, there may be multiple instances of read/write requests from one or more of the user devices 110 and/or 120 that occur at nearly the same time. For example, sometimes a single user device 110 or 120 will run multiple shards of the same machine with respect to the same library. Because each RocksDB shard runs in isolation (i.e., without inter-instance communication with other shards), and because of the identical configuration of each of the shards, multiple shards may initiate an identical background process corresponding to the library either at roughly the same time or over a short period of time. That is, because the multiple shards' background processes are not scheduled, a triggering event that causes many of the shards to initiate their processes at the same time may result in heavy disk traffic, thereby negatively effecting system performance.

By dividing the library into multiple parts respectively stored on the disk drives 160a and 160b, and by allowing different shards of the software application to each address a specific one of the multiple parts of the library, each shard will only address a portion of the data assigned to it, the addressed portion of the data corresponding to a specific one of the multiple parts of the library. Accordingly, by compartmentalizing the library in this manner, instead of one shard dealing with all of the data of the library, multiple shards each handle one of respective parts of the library, thereby improving performance of the system 100.

Referring to FIG. 2, a conventional logic monitors one or more usage metrics corresponding to the library (e.g., monitors the capacity of one or more tables of the library, monitors a number of writes to the disk drives 160a and/or 160b, and/or monitors a number of reads from the disk drives 160a and/or 160b, etc.). Once a corresponding metric, or deterministic threshold, reaches a preconfigured limit, the system may initiate one or more background maintenance processes (e.g., compaction).

For example, at operation S201, each of the shards of the one or more user devices 110 and/or 120 monitors usage metrics (e.g., monitors a capacity of a table of the library corresponding to the respective shards).

At operation S202, each shard determines whether a threshold corresponding to the usage metrics is met (e.g., each shard of the user devices 110 and 120 determines whether the capacity of the corresponding table of the library that is monitored by the shard has reached a deterministic threshold of 80% or higher). If the usage threshold is not met (e.g., if the capacity of the table is below 80%), then the shard continues to monitor the usage metrics at operation S201. If, however, the usage threshold is met (e.g., if the table monitored by the shard is at 80% capacity or higher), then the conventional logic proceeds to operation S203.

At operation S203, each of the shards, which have detected that the usage threshold of the corresponding table has been reached, initiates a background maintenance process at operation S203. The background maintenance process may include, for example, compaction.

However, because each shard independently runs its own RocksDB software, and because each shard may have access to the same system resources, the shards may concurrently become aware of the deterministic threshold being reached, which causes the background maintenance processes to be initiated. That is, because many tables of the library may have relatively the same size, and may fill with key-value data at relatively the same rate, numerous shards or user devices 110 and 120 may reach operation S203 at nearly the same time.

Accordingly, multiple shards may initiate the background maintenance processes over a short amount of time, and there may be multiple instances of a given background process being initiated at relatively the same time by multiple software applications of one or more of the user devices 110 and/or 120. Because these background processes involve access to the library (e.g., read requests and/or write requests), disk traffic with the disk drive(s) 160a and/or 160b may suddenly or drastically increase. The numerous concurrent requests by the multiple shards may cause disk traffic to increase to the point that system performance noticeably deteriorates.

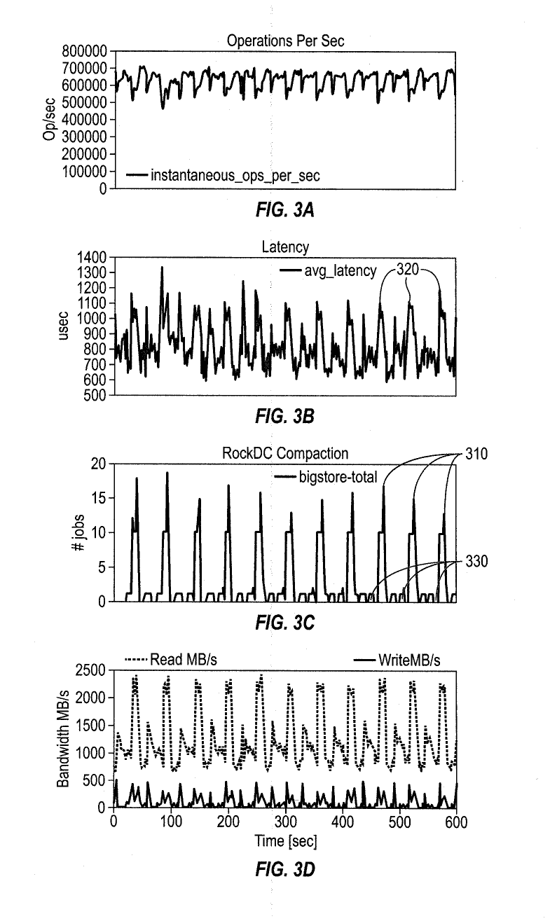

For example, when a single machine, such as user device 110, runs multiple shards of the same library, and when the library uses RocksDB to access the drives 160a and/or 160b, all shards may share the same configuration and will therefore all use the same deterministic watermark as the criteria to spawn certain background processes, such as compaction. Because many of the shards are identically configured and can also see a similar rate of disk traffic, the tables of the library fill at about the same rate, and the background maintenance process of compaction may run on all shards at about the same time. The timing of the background maintenance processes of the multiple shards may affect system performance, as shown in FIGS. 3A, 3B, 3C, and 3D.

FIGS. 3A, 3B, 3C, and 3D depict system characterization of a contemporary multi-shards database performing the conventional method of performing the background maintenance process of FIG. 2. FIGS. 3A, 3B, 3C, and 3D respectively depict graph (a) showing operations-per-second (Op/sec), graph (b) showing average latency in microseconds (usec), graph (c) showing numbers of compaction processes, or jobs (#jobs), and graph (d) showing bandwidth of read requests and of write requests in megabytes-per-second (Mb/s), each of the graphs being plotted over time (sec) from 0 seconds to 600 seconds.

As discussed above, when multiple RocksDB instances concurrently access the same drive(s) 160a and/or 160b that store the RocksDB library (e.g., when multiple shards access the library to retrieve or store data), reliance by the application on deterministic thresholds to initiate background maintenance processes may severely degrade performance of the system 100. For example, when the multiple shards determine that the corresponding usage threshold is met at operation S202, and thereby initiate compaction of the corresponding portions of the library by accessing the disk drives 160a and 160b at operation S203, disk traffic may increase such that an amount of time for handling individual read and write requests for performing compaction is noticeably lengthened.

Accordingly, because the background maintenance processes occur at roughly the same time for the multiple shards, disk traffic to the disk drives 160a and/or 160b is increased for a period of time. During this period of time, tail latencies are magnified as a result of the bursts in disk traffic, thereby creating an unnecessary and unwanted decrease in performance of the system 100.

For example, and referring to graph (c) of FIG. 3C, the number of RocksDB compaction processes interleaved over time dramatically increases (e.g., from around 3 jobs or less to around 15 jobs or more). These sudden increases 310 in the number of RocksDB compaction processes occur between periods 330 of relatively few compaction processes (e.g., around 3 or less). That is, spikes 310 in the number of compaction processes, which each correspond to a resulting period of increased disk traffic, may occur on the order of once every 50-60 seconds due to multiple shards concurrently initiating the compaction processes. This increase in the number of jobs performed with respect to the library is due to multiple shards concurrently initiating one or more background processes as the shards concurrently determine that the relevant deterministic threshold has been met at operation S202. During the increased number of background processes, there are many reads/writes from/to the disk drive(s) 160a and/or, 160b thereby causing the spikes 310 in disk traffic.

Additionally, the average latency to do a request, or the average time for each request to be served (e.g., see graph (b) of FIG. 3B), may be used as a metric for defining system performance. This metric may be a consideration for applications that store large amounts of data.

As can be in FIGS. 3B and 3C, the spikes 310 in the number of compaction processes shown in graph (c) typically correspond to spikes 320 in the time of the average tail latency shown in graph (b). The increased observed latency of requests indicated by the spikes 320 is due to the increased load on the disk drive(s) 160a and/or 160b created by the increased number of compaction processes indicated by the spikes 310 shown in graph (c). That is, if the application handles requests that are served from the disk drive(s) 160a and/or 160b, and if the disk drive(s) 160a and/or 160b is highly loaded, the requests will tend to take more time.

Because multiple shards run compaction on the tables of the library at the same time, disk traffic with respect to the disk drive(s) 160a/160b suddenly and significantly increases. These spikes in disk traffic (e.g., see graph (d) of FIG. 3D) are caused by the multiple shards each initiating compaction at about the same time, thereby creating large disk traffic over a short amount of time, while also keeping the disk relatively lightly utilized during long periods of time between events (e.g., idle time). Such spikes could potentially be reduced or avoided by instead skewing the start times of the various compaction processes to thereby have different instances run compaction at different times. Accordingly, by interleaving the compaction phases of the different instances such that they occur at different times, the maximal disk traffic is reduced. That is, system performance may be enhanced by breaking such inter-instance synced activation/triggering of maintenance procedures.

Accordingly, system performance may be improved by introducing an additional logic (e.g., randomness) to the conventional deterministic logic of FIG. 2, the additional logic also being used to start the background maintenance processes. That is, by keeping the original deterministic path of FIG. 2 while also enabling the shards to start the compaction at random by adding a parallel path that introduces a random threshold, such as random start times (e.g., start times occurring randomly according to predefined parameters), the frequency and severity of the spikes 320 in latency shown in FIG. 3B may be reduced. This is beneficial for services where multiple instances are run independently from each other, as there would otherwise be no easy way to synchronize the instances by inter-instance communication. Further, even when an inter-instance communication is available, adding randomness may solve the problem (e.g., reduce the number and magnitude of spikes in latency) with less overhead than that which would be otherwise introduced by inter-instance communication.

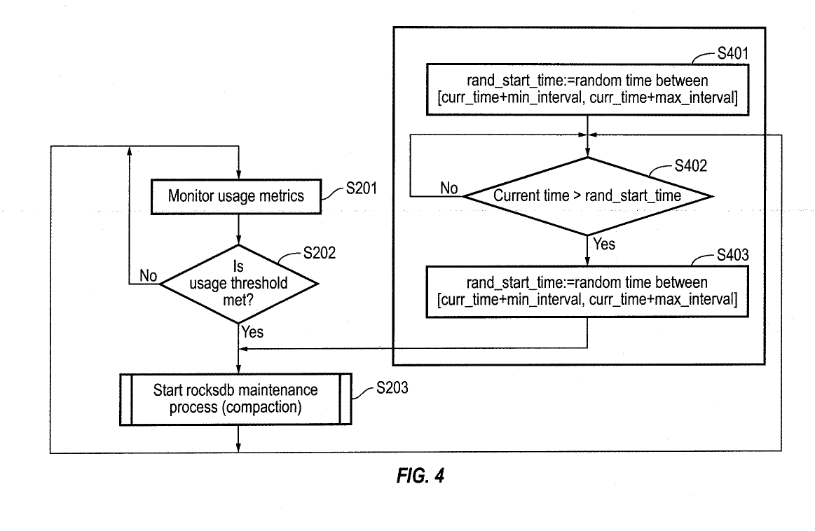

FIG. 4 is a flowchart for a method of initiating a background maintenance process of a database according to an embodiment of the present invention.

For example, and referring to FIG. 4, in the present embodiment, a random path is added as a new, parallel logic to the deterministic logic of FIG. 2. The new logic starts compaction at a random time to avoid pathological cases discussed with respect to FIGS. 3A, 3B, 3C, and 3D, where multiple instances are all used at about the same rate to thereby run compaction at about the same time. Because the added logic is configured to infrequently initiate a random compaction process, the overhead introduced by the added logic in negligible. Further, randomness provided by the added logic sufficiently reduces or prevents the aforementioned pathological cases, thereby significantly reducing the otherwise observed spikes in system resources usage.

At operation S401, time intervals (e.g., first and second time intervals, or beginning and ending time intervals, “min_interval” and “max_interval”) for a random start time may be respectively set, or configured, to a respective given time. That is, a range of future initiation times, or potentially randomly occurring start times (i.e., “rand_start_time,” as shown in FIG. 4) for initiating the compaction process may be set. Accordingly, the corresponding background maintenance process for each of the shards is configured to initiate during a randomly occurring start time occurring between configurable minimum and maximum time intervals. This randomly occurring start time “rand_start_time” will occur between times set by “curr_time+min_interval” and “curr_time+max_interval,” as shown in FIG. 4, where “curr_time” is a current clock time of the system, and “min_interval” and “max_interval” are configurable parameters that correspond to how often a random initiation is likely to happen.

For example, if “min_interval” is set to 10*60 sec, and “max_interval” is set to 60*60 sec, the random start time (“rand_start_time”) will occur between 10 mins and 1 hour from the current clock time (“curr_time”). However, if both “min_interval” and “max_interval” are set to 0 or less, the added parallel logic path (operation S401, operation S402, and operation S403) will be effectively disabled/unused (i.e. the random logic path will not be used to initiate compaction, there will be no random initiation of the compaction process, and the system will function in the same manner as the conventional system of FIG. 2). Further, if both “min_interval” and “max_interval” are set to have the same value, compaction will start at a deterministic time interval/a preset start time (e.g., a user may manually skew instances of compaction to occur at set times, and may set a different start time for each process).

At operation S402, the corresponding shard determines whether the current time (“curr_time”) is greater than the random start time (“rand_start_time”). If the current time is not greater than the random start time, then the shard returns to operation S402 (e.g., the shard continues to wait for the random start time to occur).

If the corresponding shard determines that the current time is greater than the random start time at operation S402, that is, when “curr_time” reaches the randomly chosen “rand_start_time,” the added random logic path proceeds to operation S403.

At operation S403, when “curr_time” is greater than “rand_start_time,” then a random time that occurs between “curr_time+min_interval” and “curr_time+max_interval” is chosen. Upon reaching the random time occurring between “curr_time+min_interval” and “curr_time+max_interval,” the added random logic path proceeds such that the maintenance process (e.g., compaction) is initiated at operation S203, the maintenance process being the same process that is initiated by the occurrence of the deterministic threshold as determined by the deterministic logic path of FIG. 2 (e.g., when a shard recognizes that the corresponding table has reached 80% capacity in the example provided with respect to operation S202 of FIG. 2). Accordingly, the “rand_start_time” of operation S402 effectively controls when the background process that is initiated due to randomization will begin.

In the present embodiment, the frequency at which the shards randomly start the compaction process may be configured (e.g., to occur randomly either more or less frequently). Accordingly, the random path for maintenance processes may be configured to be infrequent enough that the system continues to maintain its original characteristic with respect to the deterministic path shown in FIG. 2. However, the addition of randomness skews the instances of disk traffic to the library, thereby skewing the metrics among the shards, and more effectively balancing the system. Accordingly, even though multiple instances of the same application are all touching the RocksDB database, disk traffic is balanced over time.

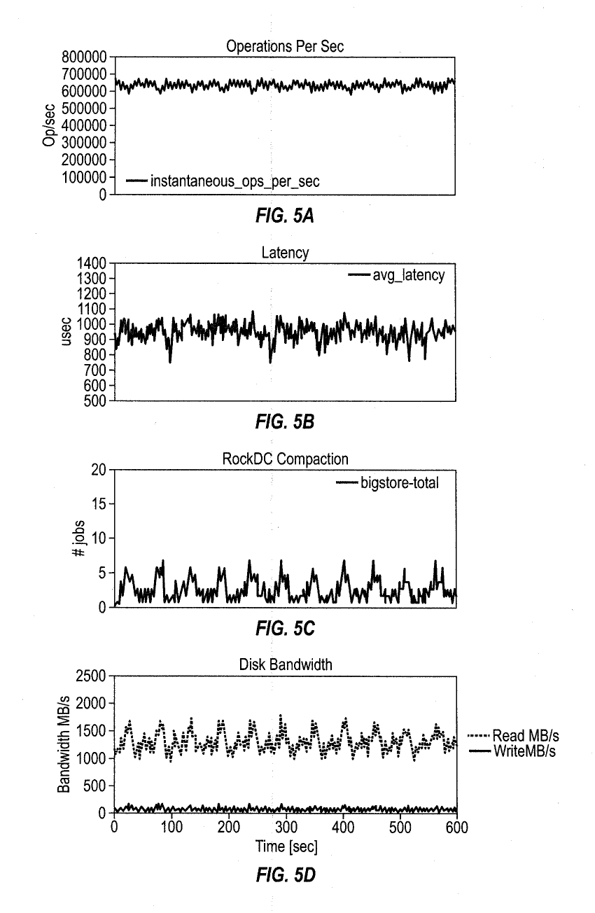

FIGS. 5A, 5B, 5C, and 5D depict system characterization of a multi-shards database performing the method of initiating the background maintenance process of the embodiment shown in FIG. 4, according to experimental results. Like, FIGS. 3A, 3B, 3C, and 3D, FIGS. 5A, 5B, 5C, and 5D respectively depict graph (a) showing operations-per-second (Op/sec), graph (b) showing average latency in microseconds (usec), graph (c) showing numbers of compaction processes, or jobs (#jobs), and graph (d) showing bandwidth of read requests and of write requests in megabytes-per-second (Mb/s), each of the graphs being plotted over time (sec) from 0 seconds to 600 seconds.

As can be seen in FIGS. 5A, 5B, 5C, and 5D, and as compared to FIGS. 3A, 3B, 3C, and 3D, the compaction processes of the different instances are skewed, or offset, as shown in graph (c) of FIG. 5C. Accordingly, the maximum disk traffic is reduced to about 1600 MB/sec (i.e., about a 36% reduction when compared to the graph (c) shown in FIG. 3C), and, as shown in graph (b) of FIG. 5B, tail latency is reduced to 1086 usec (i.e., about a 19% reduction when compared to the graph (b) shown in FIG. 3B).

As demonstrated by a comparison of FIGS. 3A, 3B, 3C, 3D, 5A, 5B, 5C, and 5D, by providing both a deterministic logic path and a random logic path, and as opposed to having only a random logic path without the deterministic logic path, the system 100 is able to perform better than operating deterministically alone. This is due to the fact that the deterministic logic path provides reliable performance, while the addition of the random path effectively skews instances of disk access to thereby reduce peak disk traffic. For example, if the deterministic logic path corresponds to capacity of tables in the library, because larger amounts of data in the tables corresponds to more efficient, faster writes to the disk drive 160a/160b, performance will therefore be better than if compaction is initiated according to only the random logic path. Further, by adding the random logic path in addition to the deterministic logic path, the spikes in disk traffic that otherwise occur are reduced and spread out.

By running the random logic path shown in FIG. 4 infrequently enough, the system 100 effectively behaves largely the same. Every shard still behaves largely the same, and will still initiate compaction upon the occurrence of the deterministic threshold corresponding to the deterministic logic path. However, the randomness introduced by the addition of the random logic path is able to skew the start times of the compaction processes initiated by the different shards. Accordingly, the addition of the random path avoids pathological cases wherein disk traffic is suddenly increased due to multiple shards following the same deterministic procedure, even though the deterministic logic path in not abandoned.

Accordingly, embodiments of the present invention solve a problem that is hard to debug and identify, that has real, detrimental effect on system performance, and that may considerably improve system performance with minimal overheads. Further, the added random logic has negligible overheads, is configurable (i.e., with respect to initiation times), can be opted-in or opted-out and can be easily disabled (i.e., the random logic path may be suspended if a purely deterministic logic path is desired).

Furthermore, in other embodiments of the present invention, the deterministic threshold of the deterministic logic path can also be randomized. For example, instead of initiating the compaction process only when it is determined that a corresponding table of the library has 80% capacity, another embodiment of the present invention may cause the compaction process to initiate when the capacity of the corresponding table is a capacity that is randomly chosen within a range of capacities. For example the random capacity for triggering a background process may exist between 70% and 80%. Occurrences of the random capacity as a triggering event may effectively skew the times at which some of the background processes are initiated, as the background processes would otherwise be initiated only upon the library reaching, in this example, 80% capacity. Additionally, ranges of quantifiable system metrics other than library capacity may be used to randomly initiate the background processes.

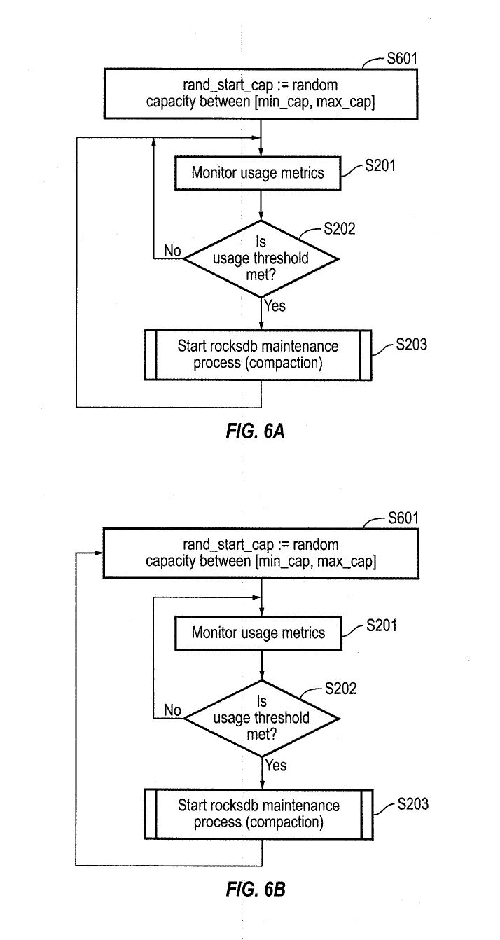

FIGS. 6A and 6B are flowcharts for methods of initiating a background maintenance process of a database according to an embodiment of the present invention.

Referring to FIGS. 6A and 6b, in both methods, at operation S601, minimum and maximum table capacities (e.g., first and second capacities corresponding to the library, or to tables within the library, “min_cap” and “max_cap”) for a randomized, process-initiating event may be set to a respective percentage (e.g., 70% and 80%, respectively). That is, a range of total used capacity may be set, the range being defined by min_cap and max_cap. A random capacity “rand_start_cap” may be used for initiating the compaction process. Accordingly, the corresponding background maintenance process for each of the shards is configured to initiate when a corresponding table of the library reaches a random level of capacity “rand_start_cap” occurring between minimum and maximum capacity levels “min_cap” and “max_cap.” Accordingly, a background process may be randomly initiated according to the occurrence “rand_start_cap,” which will occur when a capacity percentage of the table is between capacity percentages respectively set by “min_cap” and “max_cap,” as shown in FIGS. 6A and 6B, where “min_cap” and “max_cap” are configurable parameters.

Following operation S601, both methods of FIGS. 6A and 6B proceed in the same manner as the flowchart depicted in FIG. 2.

For example, at operation S201, each of the shards of the one or more user devices 110 and/or 120 monitor a capacity of a table of the library corresponding to the respective shards. At operation S202, each shard determines whether the random capacity is met. If the usage threshold is not met (e.g., if the capacity of the table is below the random capacity), then the shard continues to monitor the usage metrics at operation S201. If, however, the usage threshold is met, then the conventional logic proceeds to operation S203. At operation S203, each of the shards, which have detected that the capacity of the corresponding table has reached the random capacity, initiates a background maintenance process at operation S203. The background maintenance process may include, for example, compaction.

Thereafter, the methods of FIGS. 6A and 6B may either proceed to operation S201 to return to monitoring usage metrics, and to determine whether previously set random capacity threshold is achieved in operation S202 (e.g., FIG. 6A), or proceed to operation S601 to set a new random capacity (e.g., to change the random capacity value) before proceeding to operation S201 to return to monitoring usage metrics (e.g., FIG. 6B).

Accordingly, by randomizing the threshold capacity for each shard, the initiation of the background maintenance processes by the different shards would be skewed to thereby reduce spikes in disk traffic. This random logic path could be used in isolation, or could be used in addition to the random logic path shown in FIG. 4 (i.e., could be used as a second random path).

Although embodiments of the present invention are described with reference to RocksDB, other embodiments of the present invention are applicable for any service where maintenance processes are resource-heavy, where multiple independent instances share a resource, and where there is no other easy alternative (e.g., no available inter-instance communication) to synchronize among instances.

As described above, embodiments of the present invention provide an additional logic path for skewing disk traffic instances. Accordingly, system performance may be improved by reducing tail latency that otherwise occurs due to multiple shards concurrently initiating background maintenance processes.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The inventive concept is defined by the following claims, with equivalents of the claims to be included therein.

What is claimed is:

1. A method of managing a database, the method comprising:
determining whether a deterministic threshold has occurred;
determining whether a random threshold has occurred; and
initiating a maintenance process on the database when either the deterministic threshold or the random threshold has occurred.

2. The method of claim 1, wherein the random threshold corresponds to a start time.

3. The method of claim 2, further comprising configuring a first interval and a second interval, wherein the start time randomly occurs between the first interval and the second interval, the first and second intervals being configurable.

4. The method of claim 3, wherein when configuring of the first interval and the second interval comprises setting the first interval and the second interval to 0 or less, the result is such that the random threshold's corresponding start time does not occur.

5. The method of claim 3, wherein configuring of the first interval and the second interval comprises setting the first interval and the second interval to be equal to each other results in the maintenance process on the database starting at a fixed time.

6. The method of claim 3, further comprising reconfiguring the first interval and the second interval upon determining that the random threshold has occurred.

7. The method of claim 1, wherein the maintenance process is compaction of one or more tables of the database.

8. The method of claim 1, wherein the database comprises a key-value store library.

9. The method of claim 1, wherein the deterministic threshold corresponds to a capacity of a table of the database.

10. A database management system for maintaining a database, the system comprising:
a user device comprising:
a processor; and
memory having stored instructions that, when executed by the processor, cause the processor to:
determine whether a deterministic threshold has occurred;
determine whether a random threshold has occurred; and
initiate a maintenance process on the database when either the deterministic threshold or the random threshold has occurred.

11. The system of claim 10, wherein the random threshold corresponds to a start time.

12. The system of claim 11, further comprising configuring a first interval and a second interval, wherein the start time randomly occurs between the first interval and the second interval, the first and second intervals being configurable.

13. The system of claim 12, wherein when configuring of the first interval and the second interval comprises setting the first interval and the second interval to 0 or less, the result is such that the random threshold's corresponding start time does not occur.

14. The system of claim 12, wherein configuring of the first interval and the second interval comprises setting the first interval and the second interval to be equal to each other results in the maintenance process on the database starting at a fixed time.

15. The system of claim 12, further comprising reconfiguring the first interval and the second interval upon determining that the random threshold has occurred.

16. The system of claim 10, wherein the maintenance process is compaction of one or more tables of the database.

17. The system of claim 10, wherein the database comprises a key-value store library.

18. The system of claim 10, wherein the deterministic threshold corresponds to a capacity of a table of the database.

19. A method of scheduling access to a shared resource, the method comprising determining whether a deterministic threshold has occurred;
determining whether a random threshold has occurred; and
permitting access to the shared resource when either the deterministic threshold or the random threshold has occurred.

20. The method of claim 19, wherein entities accessing the shared resource individually determine whether the deterministic threshold or the random threshold has occurred.
